(19) United States
(12) Patent Application Publication
(10) Pub. No.: US 2002/0196069 A1
(43) Pub. Date: Dec. 26, 2002

(54) Distortion compensating circuit for electro-optical transducer

(76) Inventor: Toshiro Tanaka, Tokyo (JP)

Correspondence Address: BURNS DOANE SWECKER & MATHIS L L P, POST OFFICE BOX 1404, ALEXANDRIA, VA, 22313-1404, US

(21) Appl. No.: 10/169,581

(22) PCT Filed: Nov. 2, 2001
(86) PCT No.: PCT/JP01/09641

(30) Foreign Application Priority Data
Nov. 6, 2000 (JP) 2000-337507

(51) Int. Cl. G06G 7/12

(52) U.S. Cl. 327/362

(57) ABSTRACT

The distortion compensating circuit for an electrooptic converter includes a secondary distortion generating circuit 12, an amplitude vs. frequency characteristic compensating circuit 16 provided at an output coupling of the secondary distortion generating circuit, a distributing directional coupler 14 for distributing an RF signal provided at a previous stage of the secondary distortion generating circuit, a tertiary distortion generating circuit 13 provided at a coupling port of the distributing directional coupler, an amplitude vs. frequency characteristic compensating circuit 26 provided at a posterior stage of the tertiary distortion generating circuit, a phase vs. frequency characteristic compensating delay line 16 for a signal on the secondary distortion generating circuit side and a signal on the tertiary distortion generating circuit side, and a mixing directional coupler 15 for mixing the signal on the secondary distortion generating circuit side and the signal on the tertiary distortion generating circuit side.

### TECHNICAL FIELD

The present invention relates to a distortion compensating circuit for canceling non-linear distortion of an electrooptic converter such as a laser diode, and to a distortion compensating circuit for an electrooptic converter provided at a previous stage of a modulation input of the electrooptic converter.

### BACKGROUND ART

A broad-band frequency multiple signal transmitting communication system such as a CATV with an electrooptic converter such as a laser diode as a light-emitting source needs a very low-distortion transmission line to avoid deterioration of transmission quality due to intermodulation or the like. A conventional distortion compensating circuit for an electrooptic converter, using a diode in a distortion generating circuit, which is a distortion compensating circuit for canceling non-linear distortion of the electrooptic converter such as the laser diode with distortion generated by the distortion generating circuit provided at the previous stage of a modulation input of the electrooptic converter, is shown in a block diagram of FIG. 1.

Referring to FIG. 1, reference numeral 1 denotes an electrooptic converter using a laser diode or the like, reference numeral 2 a secondary distortion generating circuit, reference numeral 3 a distortion level adjusting parallel resistor, reference numeral 4 a distortion level adjusting series resistor, reference numerals 5 and 6 bias resistors for a distortion generating diode, reference numerals 7 through 9 DC cut capacitors, reference numeral 10 a bypass capacitor, and reference numeral 11 the distortion generating diode.

The operation of the conventional distortion compensating circuit for non-linear distortion of an electrooptic converter will be described.

In the secondary distortion generating circuit 2, the distortion generating diode 11 is biased in the reverse direction so that its operating resistance increases with an increase in potential at an RF input terminal. Therefore, the series resistance of the secondary distortion generating circuit 2 including the distortion level adjusting resistor 3 and the distortion level adjusting series resistor 4 also increases. That is, an input voltage vs. output voltage characteristic of the secondary distortion generating circuit 2 shows a sublinear characteristic in which an output voltage is compressed with respect an increase in input voltage.

Thus, when an operating current vs. optical output power characteristic of the electrooptic converter 1 shows a superlinear characteristic in which optical output power is extended with respect to an increase in operating current, nonlinear distortion (mainly secondary distortion) of the secondary distortion generating circuit and nonlinear distortion (mainly secondary distortion) of the electrooptic converter 1 have a antiphase relationship. Therefore, adjustment of the distortion level adjusting parallel resistor 3 and distortion level adjusting series resistor 4 of the secondary distortion generating circuit 2 makes it possible to generate nonlinear distortion (mainly secondary distortion) that is in a antiphase and has the same level as the nonlinear distortion (mainly secondary distortion) of the electrooptic converter 1, thereby canceling the nonlinear distortion (mainly secondary distortion) of the electrooptic converter 1 with the nonlinear distortion (mainly secondary distortion) of the secondary distortion generating circuit 2.

When the operating current vs. optical output power characteristic of the electrooptic converter 1 shows a sublinear characteristic in which optical output power is compressed with respect to an increase in operating current, the distortion generating diode 11 of the secondary distortion generating circuit 2 is reversely connected to provide a bias power supply VB1 with negative polarity, or the distortion generating diode 11 is reversely connected while the bias resistor 5, the bias resistor 6 and the bypass capacitor 10 are connected to the distortion generating diode 11, which offers an input voltage vs. output voltage characteristic of the secondary distortion generating circuit 2 with superlinear, i.e., a nonlinear distortion (mainly secondary distortion) with antiphase. This cancels nonlinear distortion (mainly secondary distortion) of the electrooptic converter 1 by the nonlinear distortion (mainly secondary distortion) of the secondary distortion generating circuit 2 in a manner similar to the above.

The conventional distortion compensating circuit for the electrooptic converter thus configured as described above forces the operating current of the electrooptic converter 1 to increase and a modulation input level thereof for the purpose of increasing the optical output power where the electrooptic converter 1 is used under a constant optical modulation condition. In order to increase the modulation input level it is necessary to increase an RF input level of the secondary distortion generating circuit 2. When the operating current and the modulation input level are increased, the nonlinear distortion generated by the electrooptic converter 1 gradually increases correspondingly. However, the secondary distortion dominates principally its distortion component. On the other hand, the nonlinear distortion of the secondary distortion generating circuit 2 gradually increases with an increase in RF input level, and tertiary, quaternary, . . . distortion also increase except the secondary distortion, particularly, the tertiary distortion thereof produces an unignorable value of about −10 db with respect to the secondary distortion. Consequently, the secondary distortion of the electrooptic converter 1 can be improved but the tertiary distortion is deteriorated.

Further, the secondary distortion generating circuit 2 has a poor distortion level (amplitude) vs. frequency characteristic, which incurs a lowered distortion level generated in a high-frequency region and hence provides incomplete cancellation of the distortion.

The present invention has been made to solve the above problems. It is an object of the present invention to provide a distortion compensating circuit for an electrooptic converter, which do not produce, particularly, tertiary distortion other than secondary distortion in a modulation input and do not deteriorate tertiary distortion of the electrooptic converter 1 even if an RF input level of a secondary distortion generating circuit 2 is increased, and which is available in a required full frequency band.

### DISCLOSURE OF THE INVENTION

A distortion compensating circuit for an electrooptic converter according to the present invention, has a secondary distortion generating circuit including a diode and a resistor connected in parallel to the diode on an AC basis, a tertiary distortion generating circuit having two reversely connected diodes, a directional coupler for distributing a signal to the secondary distortion generating circuit and the tertiary distortion generating circuit, a directional coupler for mixing signals from the secondary distortion generating circuit and the tertiary distortion generating circuit, and a delay line for compensating for phase vs. frequency characteristics of tertiary distortion generated by the secondary distortion generating circuit and tertiary distortion generated by the tertiary distortion generating circuit.

This configuration allows the compensating circuit to coincide phase vs. frequency characteristics of the tertiary distortion generated by the secondary distortion generating circuit with that generated by the tertiary distortion generating circuit. Thus, the tertiary distortion generated by the secondary distortion generating circuit is mixed with that generated by the tertiary distortion generating circuit to permit the tertiary distortion to be canceled, thereby compensating the distortion of the electrooptic converter by the secondary distortion generating circuit without deteriorating the tertiary distortion.

The distortion compensating circuit for the electrooptic converter according to. the present invention includes an amplitude vs. frequency characteristic compensating circuit in which a resistor and a capacitor are connected in parallel to each other so as to be connected in series with the diode of the secondary distortion generating circuit, and an amplitude vs. frequency characteristic compensating circuit in which a resistor and a capacitor are connected in parallel so as to be connected in series with the diodes of the tertiary distortion generating circuit.

This configuration enables the compensating circuit to share the same amplitude vs. frequency characteristics in a distortion signal generated by the secondary distortion generating circuit and in that generated by the tertiary distortion generating circuit, thereby providing a distortion signal reduced in variation in distortion amplitude in a required full frequency band.

### BRIEF DESCRIPTION OF THE DRAWINGS

FIG. 1 is a block diagram showing a configuration of a conventional distortion compensating circuit for an electrooptic converter;

FIG. 2 is a block diagram showing a configuration of a distortion compensating circuit for an electrooptic converter according to a first embodiment of the present invention;

FIG. 3 is a chart illustrating a distortion level vs. diode bias current characteristic of a secondary distortion generating circuit; and

FIG. 4 is a chart showing a distortion level vs. diode bias current characteristic of a tertiary distortion generating circuit.

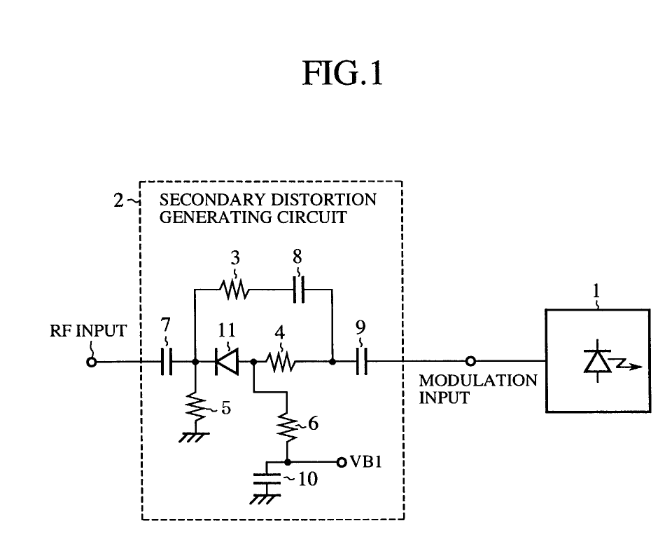

### BEST MODE FOR CARRYING OUT THE INVENTION

In order to describe the present invention in more details, the best mode for carrying out the present invention will hereinafter be described with reference to the accompanying drawings.

### First Embodiment

A distortion compensating circuit for an electrooptic converter according to the first embodiment of the present invention is directed to a distortion compensating circuit in which directional couplers are provided at an input and output of a secondary distortion generating circuit and a tertiary distortion generating circuit is provided on the coupling port sides of the directional couplers. To say more preciously, a distortion compensating circuit in which the tertiary distortion generating circuit is provided in parallel relative to the secondary distortion generating circuit and tertiary distortion generated by the secondary distortion generating circuit is cancelled with tertiary distortion generated by the tertiary distortion generating circuit to generate secondary distortion alone. A configuration of the distortion compensating circuit for implementing the above scheme will be described below.

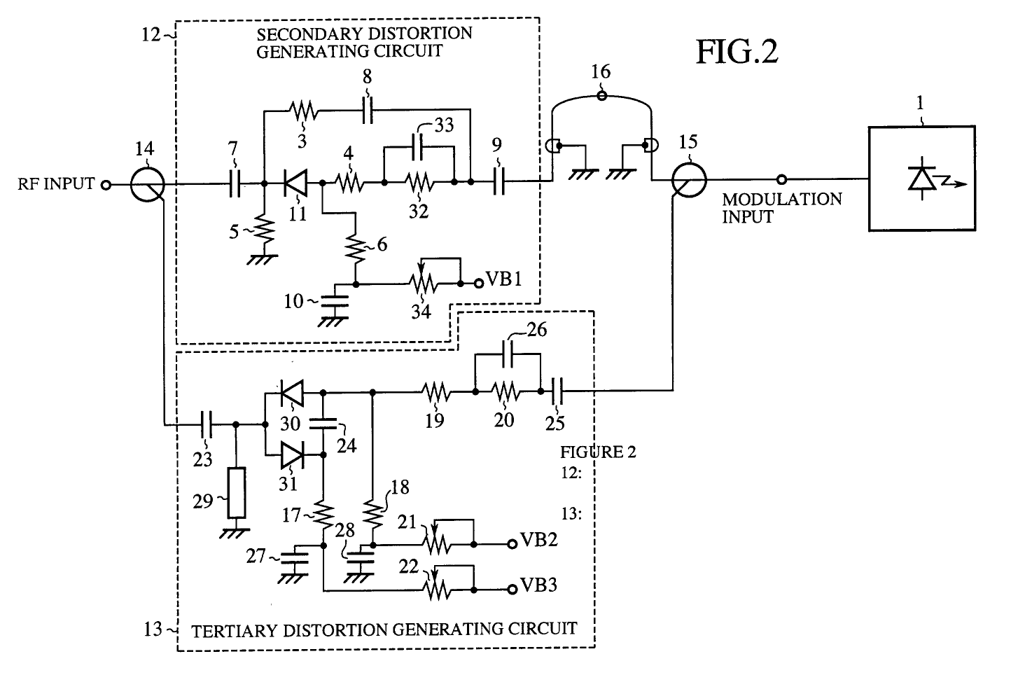

FIG. 2 is a block diagram showing a configuration of the distortion compensating circuit for the electrooptic converter according to the first embodiment of the present invention.

Referring to FIG. 2, reference numeral 1 denotes an electrooptic converter using a laser diode or the like, reference numeral 3 a distortion level adjusting parallel resistor, reference numeral 4 a distortion level adjusting series resistor, reference numerals 5 and 6 bias resistors for a distortion generating diode, reference numerals 7 to 9 DC cut capacitors, reference numeral 10 a bypass capacitor, reference numeral 11 a distortion generating diode, reference numeral 12 a secondary distortion generating circuit, reference numeral 13 a tertiary distortion generating circuit, reference numeral 14 a signal distributing directional coupler having an input/output port and a coupling port, reference numeral 15 a mixing directional coupler having an input/output port and a coupling port, and reference numeral 16 a phase vs. frequency characteristic compensating delay line for adjusting the phase of a signal outputted from the secondary distortion generating circuit 12 and that outputted from the tertiary distortion generating circuit 13. Reference numerals 17 and 18 denote bias resistors for supplying bias currents to distortion generating diodes of the tertiary distortion generating circuit 13, reference numerals 19 and 20 distortion level adjusting resistors of the tertiary distortion generating circuit 13, reference numerals 21 and 22 bias current adjusting resistors for the distortion generating diodes of the tertiary distortion generating circuit 13, reference numerals 23 through 25 DC cut capacitors, reference numeral 26 an amplitude vs. frequency characteristic compensating capacitor connected in parallel to the distortion level adjusting resistor 20 to make identical amplitude vs. frequency characteristics of tertiary distortion outputted from the tertiary distortion generating circuit 13 and that outputted from the secondary distortion generating circuit 12, reference numerals 27 and 28 bypass capacitors for eliminating noises entered from bias power supplies of the tertiary distortion generating circuit 13, reference numeral 29 a choke coil which constitutes a bias current circuit made up of distortion generating diodes 30 and 31, reference numerals 30 and 31 the tertiary distortion generating diodes, and reference numeral 32 a distortion level adjusting resistor of the secondary distortion generating circuit 12. Reference numeral 33 denotes an amplitude vs. frequency characteristic compensating capacitor connected in parallel to the distortion level adjusting resistor 32 for flattening a secondary distortion amplitude vs. frequency characteristic. Reference numeral 34 denotes a bias current adjusting resistor for the distortion generating diode 11 of the secondary distortion generating circuit 12.

The operation of the distortion compensating circuit for the electrooptic converter will next be described.

A description will be made by placing the focus on a case in which an operating current vs. optical output power characteristic of the electrooptic converter 1 is a superlinear characteristic where optical output power is extended relative to an increase in operating current.

A fundamental wave of an RF signal inputted to the distortion compensating circuit for the electrooptic converter is inputted to the input port of the distributing directional coupler 14 and distributed to an output port and a coupling port with the desired degree of coupling. The distributing directional coupler 14 and the mixing directional coupler 15 offer two types of coupling ports, i.e., equiphase or antiphase relative to the input and output ports. Here, the equiphase coupling port is taken for description.

The fundamental wave of the RF signal distributed to the output port of the distributing directional coupler 14 is inputted to the secondary distortion generating circuit 12 from which the fundamental wave of the RF signal, secondary distortion and tertiary distortion are outputted as described in BACKGROUND ART. In the secondary distortion generating circuit 12, an amplitude vs. frequency characteristic compensating circuit made up of the distortion level adjusting resistor 32 and the amplitude vs. frequency characteristic compensating capacitor 33 both connected in parallel, is inserted between the distortion level adjusting resistor 4 and the DC cut capacitor 9. Since a mixing impedance decreases on the high-frequency side in the amplitude vs. frequency characteristic compensating circuit, reductions in the distortion levels of the secondary distortion and the tertiary distortion on the high-frequency side generated by the secondary distortion generating circuit 12 are canceled out. Hence, distortion levels of the secondary distortion and tertiary distortion outputted from the secondary distortion generating circuit 12 show flat characteristics substantially constant in a full frequency band.

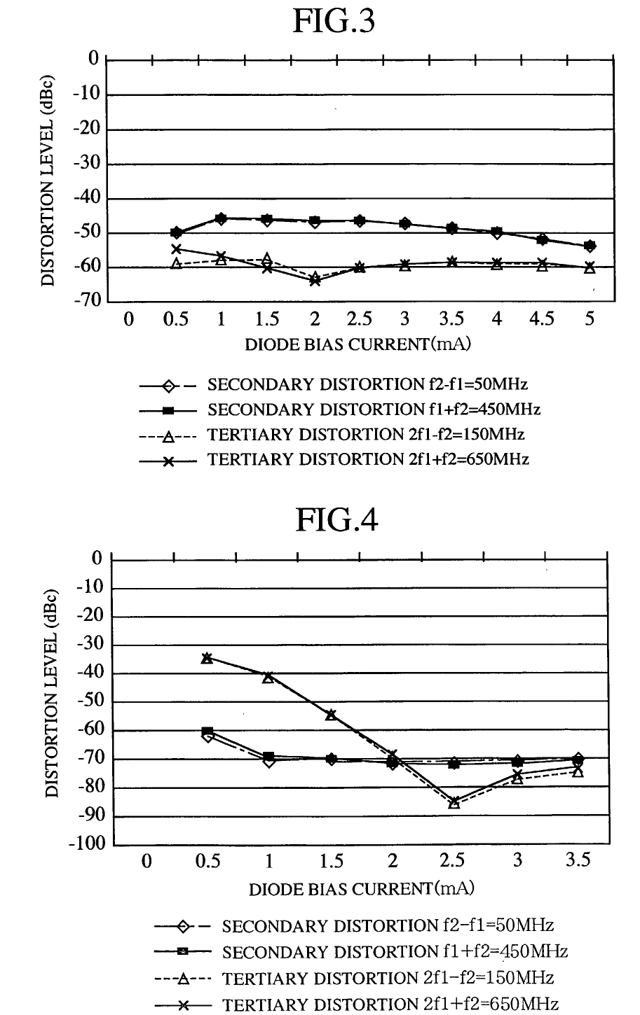

FIG. 3 is a chart illustrating characteristics of distortion levels of secondary distortion and tertiary distortion generated from the secondary distortion generating circuit 12 vs. bias currents of the distortion generating diode 11 where a fundamental wave frequency of an RF signal is set to f1=200 MHz and f2=250 MHz. As shown in FIG. 3, the tertiary distortion shows a double peak characteristic with respect to each bias current, and the phase of the tertiary distortion greatly varies in a low current region and a high current region of the bias current.

The fundamental wave of the RF signal, secondary distortion and tertiary distortion generated from the secondary distortion generating circuit 12 are inputted to the input port of the mixing directional coupler 15 through the phase vs. frequency characteristic compensating delay line 16.

On the other hand, the fundamental wave of the RF signal distributed by the coupling port of the distributing directional coupler 14 is inputted to the tertiary distortion generating circuit 13. The distortion generating diode 30 is biased in the forward direction by a bias current flowing toward the bias adjusting resistor 21, the bias resistor 18 and the choke coil 29 from the power supply VB2. Similarly, the distortion generating diode 31 is biased in the forward direction by a bias current flowing toward the bias resistor 17, the bias adjusting resistor 22 and the power supply VB3 from the choke coil 29 side.

Since the anode of the distortion generating diode 30 and the cathode of the distortion generating diode 31 are connected to each other by the DC cut capacitor 24 on an AC basis, the fundamental wave of the RF signal is inputted to the cathode of the distortion generating diode 30 and the anode of the distortion generating diode 31. Thereafter, a signal obtained by mixing the fundamental wave of the RF signal having passed through each of the distortion generating diode 30 and the distortion generating diode 31 is outputted from the tertiary generating circuit 13.

The distortion generating diode 30 and the distortion generating diode 31 are reversely connected to each other with respect to the input and output of the tertiary generating circuit 13. Therefore, diodes with substantially identical characteristics such as a bias current vs. bias voltage characteristic, etc., should be used. When they are utilized under the same bias current conditions, the secondary distortion respectively generated through the distortion generating diode 30 and the distortion generating diode 31 is in antiphase and has the same amplitude level. This cancels the secondary distortion generated by the tertiary distortion generating circuit 13 and reduces it to a small level.

The output of the tertiary distortion generating circuit 13 is outputted via the distortion level adjusting resistor 19 to which the outputs of the distortion generating diodes 30 and 31 are connected in series, an amplitude vs. frequency characteristic compensating circuit made up of the distortion level adjusting resistor 20 and the amplitude vs. frequency characteristic compensating capacitor 26 both connected in parallel, and the DC cut capacitor 25. The output thereof is compensated for a distortion's amplitude vs. frequency characteristic so that a distortion level in a full frequency band shows a substantially constant flat characteristic in a manner similar to the output of the secondary distortion generating circuit 12 in accordance with the frequency characteristic of the amplitude vs. frequency characteristic compensating circuit made up of the distortion level adjusting resistor 20 and the amplitude vs. frequency characteristic compensating capacitor 26.

FIG. 4 is a chart illustrating characteristics of distortion levels of secondary distortion and tertiary distortion generated from the tertiary distortion generating circuit 13 vs. bias currents of the distortion generating diodes 30 and 31 where a fundamental wave frequency of an RF signal is set to f1=200 MHz and f2=450 MHz. As shown in FIG. 4, the characteristics show that the tertiary distortion are generated only in low current regions of the bias currents and canceled out in high current regions by the mutually reversely connected distortion generating diodes 30 and 31 in a manner similar to the secondary distortion.

To be more precise, the tertiary distortion generated from the tertiary distortion generating circuit 13 has such a relationship that it is in equiphase with respect to the distortion in the low current region of the tertiary distortion generated by the secondary distortion generating circuit 12 shown in FIG. 3 and in antiphase with respect to the distortion in the high current region. The fundamental wave of the RF signal outputted from the tertiary distortion generating circuit 13, and the tertiary distortion therefrom are inputted to the input port of the mixing directional coupler 15. After that, the fundamental wave of the RF signal, the secondary distortion and the tertiary distortion are mixed together at the coupling port of the mixing directional coupler 15 with the desired degree of coupling and the mixed distortion is in turn outputted to the output port thereof.

If the bias current flowing through the distortion generating diode 11 of the secondary distortion generating circuit 12 is set to a predetermined current value in a high current region in which the secondary distortion of the electrooptic converter 1 can be canceled, and an electrical line length on the secondary distortion generating circuit 12 side extending from the distributing directional coupler 14 to the mixing directional coupler 15 and that on the tertiary distortion generating circuit 13 side extending from the distributing directional coupler 14 to the mixing directional coupler 15 are set identical to each other, then the tertiary distortion generated by the secondary distortion generating circuit 12 and that generated by the tertiary distortion generating circuit 13 is in antiphase. Thus, by setting a tertiary distortion level generated by adjusting the bias currents flowing through the distortion generating diodes 30 and 31 of the tertiary distortion generating circuit 13, to the same level as that of the tertiary distortion generated by the secondary distortion generating circuit, the tertiary distortion in a low-frequency region can be canceled.

Since, however, phase vs. frequency characteristics having the tertiary distortion generated by the secondary distortion generating circuit 12 and the tertiary distortion generated by the tertiary distortion generating circuit 13 are different from each other, the tertiary distortion in a high-frequency region failed to completely canceled. Normally, the phase vs. frequency characteristic compensating delay line 16 is provided at a posterior stage of the secondary distortion generating circuit 12 by reason that the phase of the tertiary distortion generated by the tertiary distortion generating circuit 13 tends to lag. This cancels the tertiary distortion in the full frequency band.

Since the distortion level of the tertiary distortion generated by the tertiary distortion generating circuit 13 changes in accordance with the level of the fundamental wave of the RF signal inputted to the tertiary distortion generating circuit 13, the degree of coupling of the distributing directional coupler 14 is set to such an extent that an appropriate tertiary distortion level is obtained. Since the tertiary distortion outputted from the tertiary distortion generating circuit 13 is mixed with the signal outputted from the secondary distortion generating circuit 12 at the coupling port of the mixing directional coupler 15, the degree of coupling of the mixing directional coupler 15 is set to such an extent that the tertiary distortion outputted from the tertiary distortion generating circuit 13 come up to the same level as the tertiary distortion outputted from the secondary distortion generating circuit and the level enough to cancel the tertiary distortion is obtained, at the output of the mixing directional coupler 15.

On the other hand, the provision of the phase vs. frequency characteristic compensating delay line 16 for the tertiary distortion produces a difference between the electrical line lengths with respect to the fundamental wave outputted from the secondary distortion generating circuit 12 and the fundamental wave outputted from the tertiary distortion generating circuit 13, which deteriorates an amplitude vs. frequency characteristic of a mixed signal of the fundamental waves due to interference characteristics of both signals. Therefore, it is necessary to set the fundamental wave level on the tertiary distortion generating circuit 13 side as small as possible as compared with the fundamental wave level on the secondary distortion generating circuit 12 side, i.e., set the degrees of coupling of the distributing directional coupler 14 and the mixing directional coupler 15 as small as possible.

In view of the above facts, the degrees of coupling of the distributing directional coupler 14 and the mixing directional coupler 15 are respectively set to about −10 dB to about −15 dB in terms of a power ratio in consideration of the generation of desired tertiary distortion required for cancellation by the tertiary distortion generating circuit 13 and the interference of the fundamental wave. Meanwhile, the above description has been made by placing the focus on the case in which the operating current vs. optical output power characteristic of the electrooptic converter 1 is the superlinear characteristic in which the optical output power is extended with respect to the increase in operating current. However, when the operating current vs. optical output power characteristic of the electrooptic converter 1 is a sublinear characteristic in which optical output power is compressed with respect to an increase in operating current, the distribution generating diode 11 of the secondary distortion generating circuit 12 should be reversely connected to offer the bias source VB1 with negative polarity, or while the bias resistor 5 should be connected to the cathode side of the distortion generating diode 11 so as to be reverse direction with respect to the bias resistor 6, the bias adjusting resistor 34 and the bypass capacitor 10 which are connected to the anode side of the distortion generating diode 11, for supplying a forward bias current.

When the secondary distortion generating circuit 12 is configured with the distortion generating diode 11 reversely connected, the antiphase secondary distortion is generated. Even when the operating current vs. optical output power characteristic of the electrooptic converter 1 is the sublinear characteristic in which the optical output power is compressed with respect to the increase in the operating current, the secondary distortion generated by the electrooptic converter 1 can be canceled.

However, since when the bias current flowing through the distortion generating diode 1 is set to a high current region, the secondary distortion generating circuit 12 generates the antiphase tertiary distortion, either the distributing directional coupler 14 or the mixing directional coupler 15 with the antiphase coupling port with respect to the input port or output port should be used, in order to cancel the tertiary distortion generated by the secondary distortion generating circuit 12 with the tertiary distortion generated by the tertiary distortion generating circuit 13.

### INDUSTRIAL APPLICABILITY

Since a distortion compensating circuit for an electrooptic converter according to the present invention is capable of effectively removing tertiary distortion, it is qualified for removal of distortion from a modulation input of the electrooptic converter which amplifies an optical output.

1. A distortion compensating circuit for an electrooptic converter, comprising:
a secondary distortion generating circuit including a diode and a resistor connected in parallel to the diode on an AC basis;
a tertiary distortion generating circuit having two reversely connected diodes;
a directional coupler for distributing a signal to said secondary distortion generating circuit and said tertiary distortion generating circuit;
a directional coupler for mixing signals from said secondary distortion generating circuit and said tertiary distortion generating circuit; and
a delay line for compensating for phase vs. frequency characteristics of tertiary distortion generated by said secondary distortion generating circuit and tertiary distortion generated by said tertiary distortion generating circuit.

2. The distortion compensating circuit according to claim 1, further comprising:
an amplitude vs. frequency characteristic compensating circuit in which a resistor and a capacitor are connected in parallel so as to be connected in series with the diode of said secondary distortion generating circuit; and
an amplitude vs. frequency characteristic compensating circuit in which a resistor and a capacitor are connected in parallel to each other so as to be connected in series with the diodes of said tertiary distortion generating circuit.
